(19) United States
(12) Patent Application Publication
(10) Pub. No.: US 2013/0250878 A1
(43) Pub. Date: Sep. 26, 2013

(54) APPARATUS AND METHOD FOR MACHINE-TYPE COMMUNICATIONS

(71) Applicant: SAMSUNG ELECTRONICS CO., LTD., Suwon-si (KR)

(72) Inventors: Krishna Sayana, San Jose, CA (US); Yong-Han Nam, Richardson, TX (US); Boon Loong Ng, Richardson, TX (US)

(73) Assignee: SAMSUNG ELECTRONICS CO., LTD, Suwon-si (KR)

(21) Appl. No.: 13/837,350

(22) Filed: Mar. 15, 2013

Related U.S. Application Data
(60) Provisional application No. 61/615,097, filed on Mar. 23, 2012.

(51) Int. Cl. H04W 4/00

(52) U.S. Cl. CPC H04W 4/005
USPC 370/329

(57) ABSTRACT

For use in a wireless network, a method for supporting a Machine-Type Communication (MTC) User Equipment (UE) is provided. The method comprises transmitting an MTC-specific Master Information Block (M-MIB) carrying information specific to a User Equipment (UE), via a MTC Physical Broadcast Channel (M-PBCH) to the MTC UE. The M-PBCH is transmitted in a M-PBCH subframe being different from a Physical Broadcast Channel (PBCH) subframe in which a PBCH is transmitted.

### CROSS-REFERENCE TO RELATED APPLICATION(S) AND CLAIM OF PRIORITY

The present application claims priority to U.S. Provisional Patent Application Ser. No. 61/615,097, filed Mar. 23, 2012, entitled “PBCH DESIGNS TO SUPPORT MTC TYPE DEVICES IN LTE”. The content of the above-identified patent document is incorporated herein by reference.

### TECHNICAL FIELD

The present application relates generally to wireless communications and, more specifically, to a method and apparatus for supporting machine-type communications.

### BACKGROUND

Machine Type Communications (MTC) or Machine-to-Machine (M2M) communications are expanding rapidly. MTC (or M2M) is a form of communication that involves one or more entities that do not necessarily require human interaction. MTC devices include meters, sensors, healthcare devices, cars, smart phones, road security, and other consumer electronic devices. Since machines are excellent at routine and well-defined tasks that require a constant level of attention and machines can react to inputs very quickly, MTC devices allow people to avoid dull and repetitious work.

### SUMMARY

For use in a wireless network, a method for supporting a Machine-Type Communication (MTC) User Equipment (UE) is provided. The method comprises transmitting an MTC-specific Master Information Block (M-MIB) carrying information specific to a User Equipment (UE), via a MTC Physical Broadcast Channel (M-PBCH) to the MTC UE. The M-PBCH is transmitted in a M-PBCH subframe being different from a Physical Broadcast Channel (PBCH) subframe in which a PBCH is transmitted.

A base station configured to communicate with at least one user equipment (UE) configured for machine type communications (MTC) is provided. The base station comprises a transmitter configured to transmit an MTC-specific Master Information Block (M-MIB) carrying information specific to User Equipment (UE), via a MTC Physical Broadcast Channel (M-PBCH) to MTC UE. The M-PBCH is transmitted in a M-PBCH subframe being different from a Physical Broadcast Channel (PBCH) subframe in which a PBCH is transmitted.

A machine type communications (MTC) User Equipment (UE) configured to communicate with at least one base station is provided. The MTC UE comprises a receiver configured to receive an MTC-specific Master Information Block (M-MIB) carrying information specific to User Equipment (UE), via a MTC Physical Broadcast Channel (M-PBCH) to MTC UE. The M-PBCH is received in a M-PBCH subframe being different from a Physical Broadcast Channel (PBCH) subframe in which a PBCH is received.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates machine-type communication devices according to the disclosure;

FIG. 2 illustrates bandwidth reduction according to embodiments of the present disclosure;

FIG. 3 illustrates a process wherein a UE obtains System Information Blocks (SIBs) according to the present disclosure;

FIG. 4 illustrates synchronization signals according to embodiments of the present disclosure;

FIG. 5 illustrates a physical broadcast channel according to embodiments of the present disclosure;

FIGS. 6A and 6B illustrate mapping M-PBCH across the certain number of OFDM symbols according to embodiments of the present disclosure;

FIGS. 7A through 7D illustrate mapping M-PBCH across a subframe according to embodiments of the present disclosure;

FIGS. 8 A through 8D illustrate mapping M-PBCH across a subframe with an offset according to embodiments of the present disclosure;

FIG. 9 illustrates a PRB index for the center 6 PRBs of the system BW according to embodiments of the present disclosure;

FIGS. 10A through 10F illustrate M-MIB structures according to embodiments of the present disclosure;

FIG. 11 illustrates an exemplary wireless network according to one embodiment of the present disclosure; and

FIG. 12 illustrates a wireless mobile station according to embodiments of the present disclosure.

### DETAILED DESCRIPTION

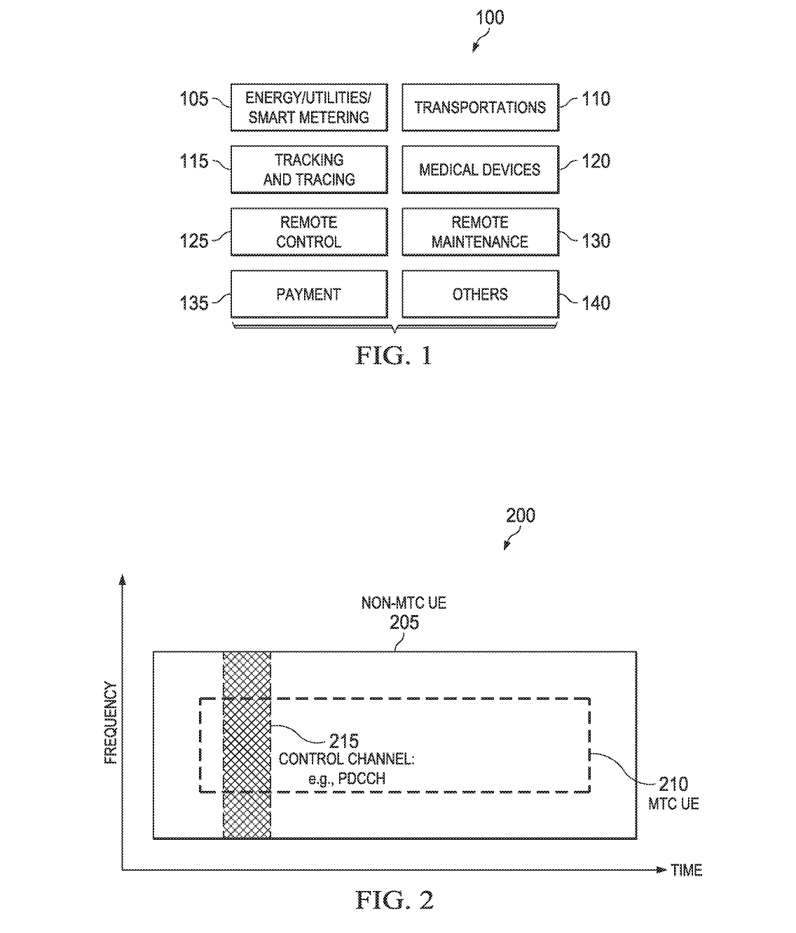

FIGS. 1 through 12, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless communication system.

The following documents and standards descriptions are hereby incorporated into the present disclosure as if fully set forth herein: (i) 3GPP Technical Specification No. 36.211, version 10.1.0, “E-UTRA, Physical Channels and Modulation” (hereinafter “REF1”); (ii) 3GPP Technical Specification No. 36.212, version 10.1.0, “E-UTRA, Multiplexing and Channel Coding” (hereinafter “REF2”); and (iii) 3GPP Technical Specification No. 36.213, version 10.1.0, “E-UTRA, Physical Layer Procedures” (hereinafter “REF3”).

With regard to the following description, it is noted that the LTE terms “node B,” “enhanced node B,” and “eNodeB” are other terms for “base station” used below. A base station, as described herein, may have a globally unique identifier, known as a base station identifier (BSID). For some embodiments, the BSID may be a MAC ID. Also, a base station can have multiple cells (e.g., one sector can be one cell), each with a physical cell identifier, or a preamble sequence, which may be carried in a synchronization channel. In addition, the LTE term “user equipment” or “UE” is another term for “subscriber station” used below, and a “mobile station” as described herein is interchangeable with a “subscriber station.”

Further, MTC (or M2M) is a form of communication that involves one or more entities that do not necessarily require human interaction. An MTC UE is a terminal being capable of MTC. A regular UE, or a non-MTC UE, refers to a UE that is a regular UE and that can use the system designed for a regular UE, not the special system designed for an MTC UE. The terms are mainly applicable in 3GPP/LTE/LTE-A, however, the technologies are not limited to these systems, rather, they can be applied to other systems where the terms may be called other names.

FIG. 1 illustrates machine-type communication devices according to the disclosure. The embodiment of the machine-type communication (MTC) devices shown in FIG. 1 is for illustration only. Other embodiments could be used without departing from the scope of this disclosure.

Examples of MTC devices 100 include metering 105, road security and wireless connectivity in automobiles 110, tracking and tracing 115, healthcare devices 120, remote controls 125, remote maintenance 130, payment systems 135, and others 140 including consumer electronic devices, such as smart phones, e-book readers, digital picture frames, connected sports devices, and the like. MTC also is important for many emerging use cases.

The communication functionalities defined for a Long Term Evolution (LTE) User Equipment (UE) can be supported by MTC UEs as well. However, in order to tailor the cost of terminals for the low-end of the MTC market to be competitive with that of Global System for Mobile Communications (GSM)/General Packet Radio Service (GPRS) terminals, it can be considered that low cost MTC UEs support a limited set of functionalities compared to normal UEs, toward reducing the implantation cost and complexity with meeting the performance requirements for low cost MTC UEs at the same time. The feature down-selection may be applicable to low cost voice-support LTE UEs in the future, if necessary.

In 3GPP RAN #53 meeting, the study item for low-cost MTC (machine-type communications) UEs based on LTE was approved (See RP-111112, “SID: Provision of low-cost MTC UEs based on LTE”, 3GPP TSG RAN#53, Vodafone, Fukuoka, Japan, 13-16 Sep. 2011, the contents of which are hereby incorporated by reference in their entirety). Embodiments, of the present disclosure provide methods, systems and an apparatus to support a low cost MTC UEs (also referred to as a LTE-Lite UE).

Certain embodiments of the present disclosure provide methods for reducing RF component cost in the devices, including (for example) simplifications and reductions in support of bands/RATS/RF chains/antenna ports, transmission power, maximum channel bandwidth less than the maximum specified for respective frequency band, and support of half-duplex FDD mode.

Certain embodiments of the present disclosure provide methods for reducing the processing in the device, additionally considering baseband-RF conversion aspects, significantly lower peak data rate support, no support of spatial processing mode in uplink/downlink, and reduced radio protocol processing.

Certain embodiments of the present disclosure provide features to allow cost reduction, but which also bring a reduction in LTE system performance. Certain embodiments are restricted to devices that only operate as MTC devices not requiring high data rates and/or low latency, after further careful study.

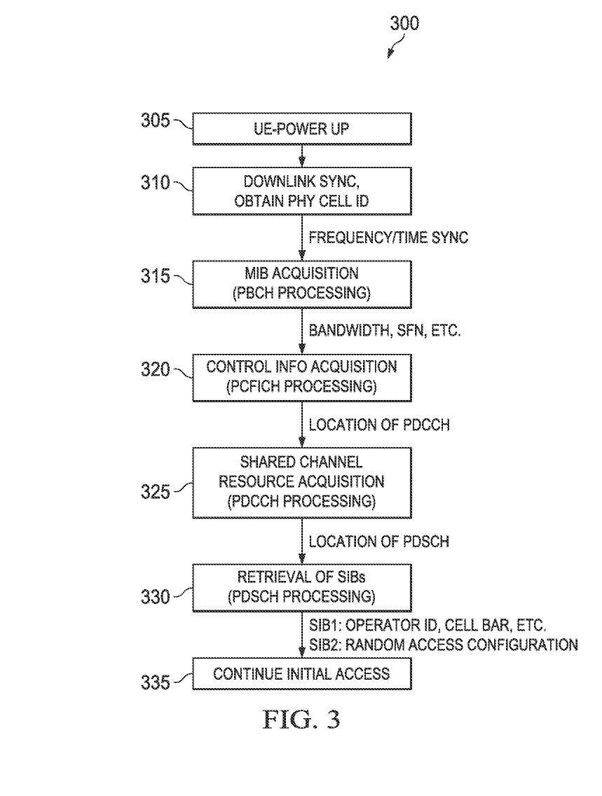

FIG. 2 illustrates bandwidth reduction according to embodiments of the present disclosure. The embodiment of the bandwidth reduction 200 shown in FIG. 2 is for illustration only. Other embodiments could be used without departing from the scope of this disclosure.

In certain embodiments, bandwidth reduction 200 is supported for low cost MTC UE. The MTC UE and regular UE can coexist in the same band. The non-MTC UE can use time and frequency resources in a first location 205. Note that non-MTC UE and regular UE can be interchangeable, and they are used to stand for the UE which uses regular protocol which can be for non-MTC UE. The MTC UE can use time and frequency resources in a second location 210. Note that the resources in the second location 210 may be shared by the MTC UE and non-MTC UE.

In certain embodiments, in order to meet the low cost target with low data rate support, MTC UEs support small channel bandwidth, such as illustrated as the reduced bandwidth in the second location 210, such as 1.4 MHz. This can correspondingly reduce complexity and cost of RF/IF filters, FFT/IFFT components, ADC/DAC, other digital processing circuitry, and the like.

However, when the MTC UEs with narrow bandwidth transmission/reception capability access a cell with wider system bandwidth, some issues arise. For example, the MTC UEs cannot understand PDCCH (physical downlink control channel) 215, whose transmission is spread over the whole downlink transmission bandwidth, resulting that PDSCH (physical downlink shared channel, including the one conveying SIB) scheduled via the PDCCHs cannot be decoded by the MTC UEs. The same problem exists for PCFICH (Physical Control Format Indicator Channels) and PHICH (Physical Hybrid-ARQ (Automatic Repeat reQuest) Indicator Channels) as well. Embodiments of the present disclosure address these issues.

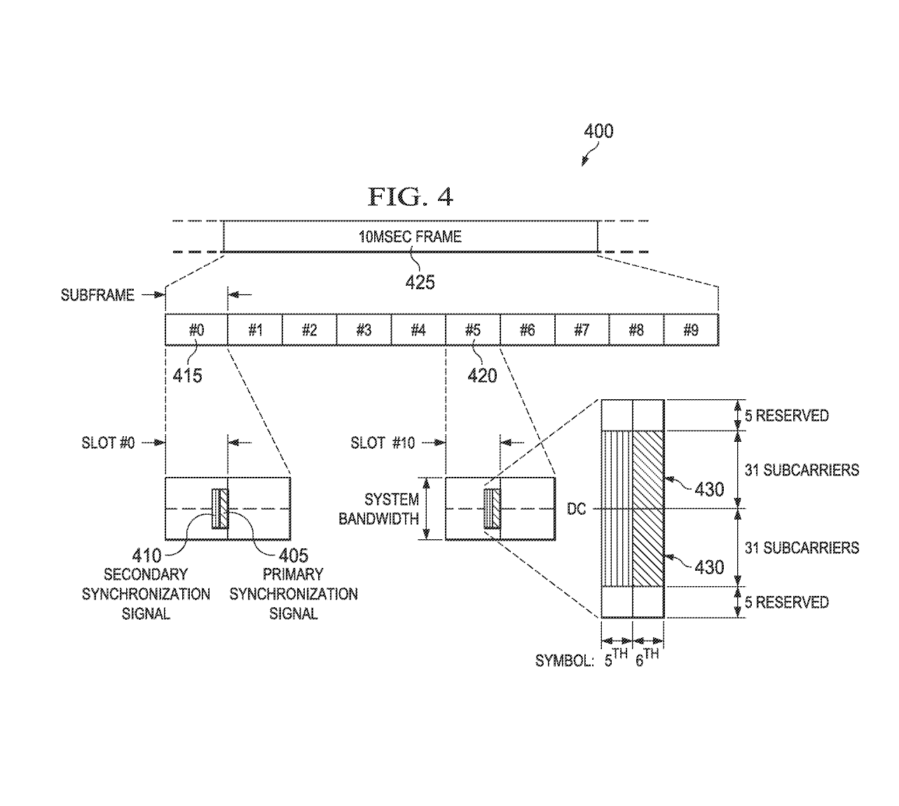

FIG. 3 illustrates a process wherein a UE obtains system information blocks (SIBs) according to the present disclosure. For Physical Broadcast Channel (PBCH) detection: To detect PBCH, the UE needs to know cell specific reference signal (CRS). To know the location of CRS, the UE needs to blind decode the number of antenna ports (1, 2, 4 ports), hypothesis testing on PBCH decoding. Once the port numbers are known, the UE knows how many CRSs it is expecting to read. For measurement (Reference Signal Received Power (RSRP), Reference Signal Received Quality (RSRQ)) purpose, port zero is used mostly, and port 1 is also used in some cases.

In block 305, the UE powers up. The UE obtains the physical (PHY) cell ID in block 310. The UE performs a downlink sync, such as a frequency/time sync. The PHY cell ID is the preamble in the synchronization channel. In block 315, the UE performs Master Information Block (MIB) acquisition by PBCH processing (e.g., bandwidth, Superframe Number (SFN), and so forth). Control information acquisition, using the Physical Control Channel Format Indication Channel (PCFICH) occurs in block 320 to determine the location of the Physical Downlink Control Channel (PDCCH). The PDCCH is processed in block 325 for shared channel resource acquisition to determine the location of the Physical Downlink Shared Channel (PDSCH) (typically for data channel and some control channel). In block 330, the UE performs PDSCH processing to retrieve the System Information Block (SIB), which is the broadcast information that each UE may need to know. Thereafter, the UE continues initial access in block 335.

The PDCCH for MTC UEs can be different from the PDCCH for regular UEs. The PDCCH for MTC UEs is denoted as L-PDCCH (lite PDCCH). Note that L-PDCCH can also be of another name, such as E-PDCCH or enhanced PDCCH. The L-PDCCH can also be a version of PDCCH with some additional changes for the consideration of support for MTC UE. The system information for MTC UE can be in the System Information Block for MTC UE (M-SIB). The M-SIB can include some system information unique to MTC UE (e.g., information not needed for regular UE), such as the configuration information of ePDCCH, e.g., the time and frequency location of the e-PDCCH, information related to search space composition, and so forth.

Time synchronization is one of the first steps in establishing communication between two devices. Existing wireless communication systems, including WiFi, CDMA/CDMA2000/1xEV-DO, GSM/WCDMA/HSPA, mobile WiMAX, and LTE/LTE-Advanced systems, all have carefully designed time synchronization signals and procedures.

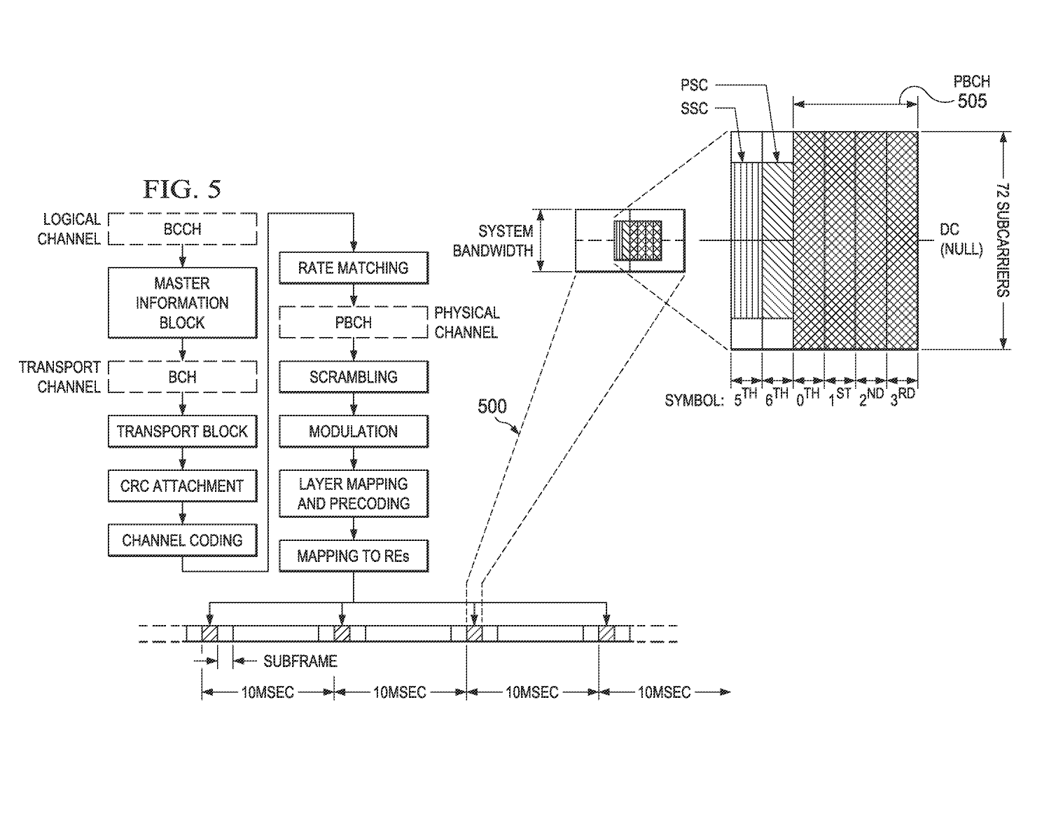

FIG. 4 illustrates synchronization signals in an LTE system according to embodiments of the present disclosure. The embodiment of the synchronization signals 400 shown in FIG. 4 is for illustration only. Other embodiments could be used without departing from the scope of this disclosure.

The primary synchronization signal (PSS) 405 and secondary synchronization signal (SSS) 410 may be used to allow the UE to synchronize to the timing of the base station. The PSS 405 and SSS 410 are transmitted in both subframe #0 415 and subframe #5 420 in every 10 ms frame 425. In each occurrence, both the PSS 405 and the SSS 410 occupy the center 72 subcarriers (with five (5) subcarriers on each side reserved).

The sequence used for the SSS 410 is an interleaved concatenation of two binary sequences 430, each having a length of thirty-one (31). The concatenated sequence is scrambled with a scrambling sequence given by the PSS (405). The combination of two thirty-one length sequences 430 defining the SSS 410 differs between subframe #0 415 and subframe #5 420 in order for the UEs to detect the 10 ms frame timing. The choice of the two thirty-one length binary sequences 430 is linked to the physical-layer cell-identity group N_{ID}⁽¹⁾, which allows the UEs to detect the value of the physical-layer cell-identity group N_{ID}⁽¹⁾ by detecting the SSS.

Additionally, the frame boundary and the starting position of the 40 ms (four frames) boundary can be detected via a physical broadcast channel (PBCH).

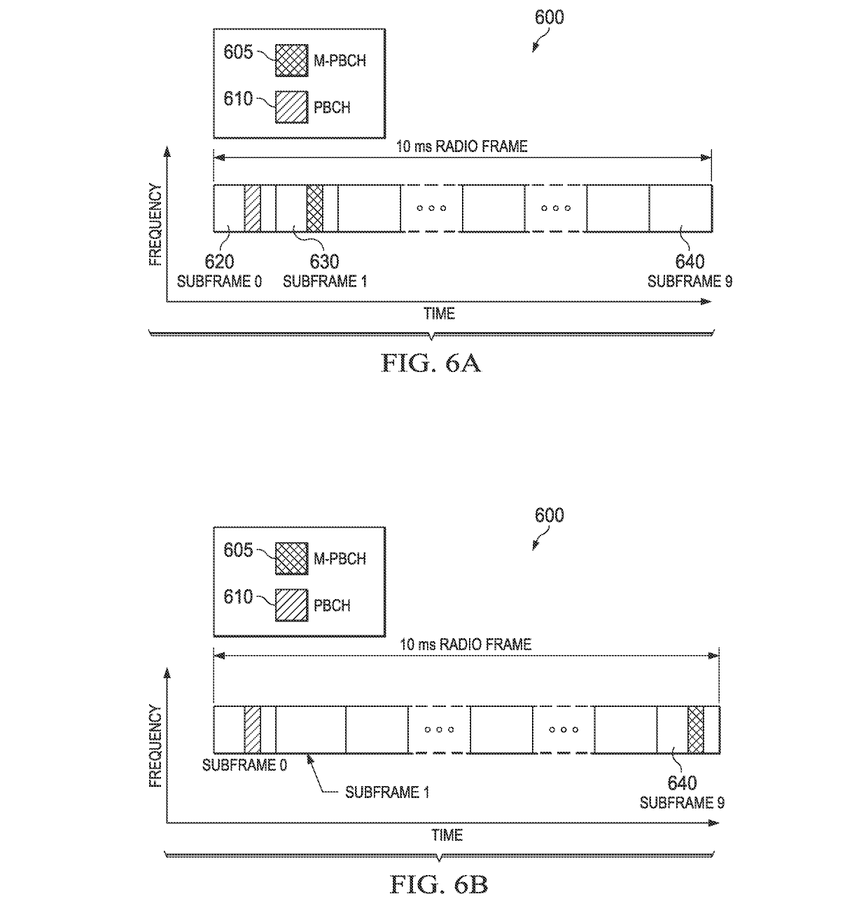

FIG. 5 illustrates a physical broadcast channel according to embodiments of the present disclosure. The embodiment of the PBCH 500 shown in FIG. 5 is for illustration only. Other embodiments could be used without departing from the scope of this disclosure.

A PBCH transport block 505 is transmitted in subframe #0 of the four (4) consecutive frames in a 40 ms interval. The PBCH 505 signal is scrambled with a scrambling sequence that is initialized every 40 ms by the cell ID in the first subframe of a frame with a system frame number (SFN) that is a multiple of 4. This design enables the UEs to detect the 40 ms timing by detecting the PBCH.

Embodiments of the present disclosure illustrate a new PBCH for supporting a MTC UE(M-PBCH). The M-PBCH is described in exemplary embodiments according to the present disclosure.

In association with M-PBCH decoding in a UE, CRS may or may not be available, depending on the system architecture. In embodiments in which the CRS is available, M-PBCH are transmitted in the center 6RBs, which is the same band of the PBCH for the non-MTC UEs. Then the MTC UE can access the center band to receive M-PBCH decodable using CRS. However accessing the center band may preclude support of MTC UEs on any new carrier that does not support CRS.

In embodiments in which DMRS are supported, such as the LTE Rel-10 system, DMRS can be reused for decoding M-PBCH, while utilizing a few reserved bits in the MIB for carrying MTC-specific information. In this case, DMRS can collide with locations of PSS/SSS when the PBCH and PSS/SSS are transmitted in the same subframe. To address the collision issue, in certain embodiments, a base station can slightly modify the DMRS pattern to avoid the PSS/SSS. Consequently, a new implementation of channel estimation is needed and, further, the MTC UEs share the same MIB with the UEs.

In certain embodiments, MTC-specific MIB (M-MIB) carrying information specific to MTC is separately designed from MIB. M-MIB is further carried by M-PBCH, which is separately sent in a different subframe from the subframe transmitting the PBCH, i.e., subframe 0.

In certain embodiments, M-PBCH is sent periodically. For example, M-PBCH is transmitted every 10 milliseconds (ms) in the n-th subframe, denoted as n_{M-PBCH}. In one example, n_{M-PBCH}=1, where M-PBCH is sent in the second subframe, which is the next right subframe to the subframe in which the PBCH 505 is sent. In another example, n_{M-PBCH}=9, where M-PBCH is sent in the tenth subframe, which enables the UE to keep commonality between FDD and TDD for the M-PBCH mapping since most TDD subframe configurations have DL subframe in the ninth subframe.

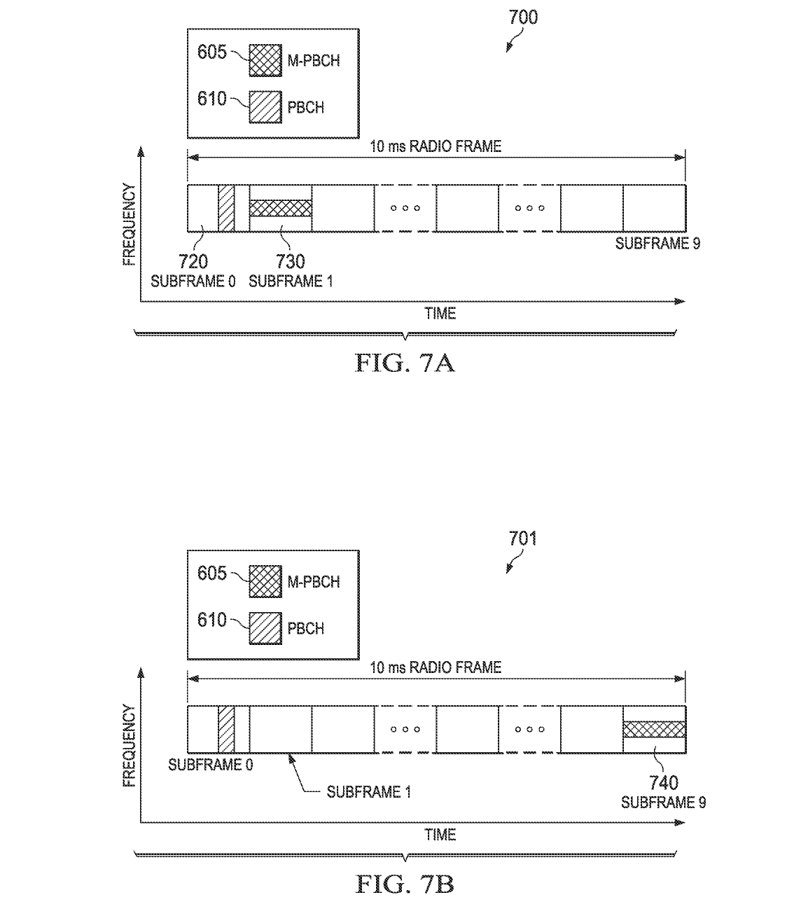

FIGS. 6A and 6B illustrate mapping M-PBCH across the OFDM symbols according to embodiments of the present disclosure. The embodiments of the M-PBCH mapping 600 shown in FIGS. 6A and 6B are for illustration only. Other embodiments of M-PBCH mapping 600 to a subframe could be used without departing from the scope of this disclosure.

The M-PBCH 605 is mapped across one or more Physical Resource Blocks (PRBs) out of the center 6 PRBs of the system bandwidth (BW) in a subframe different from the subframe where the PBCH 610 is transmitted. For example, in FIG. 6A, M-PBCH 605 is transmitted in subframe 1 630 while PBCH 610 is transmitted in subframe 0 620.

In one embodiment, as shown in FIG. 6A, M-PBCH 605 is mapped across OFDM symbols 0 to 3 in slot #1 of n_{M-PBCH}. For example, M-PBCH 605 can be sent in OFDM symbols 0, 1, 2, 3 in slot #1 of every second subframe 630 of each radio frame, i.e., n_{M-PBCH}=1. In a system, such as an LTE system, having a radio frame with a length of 10 ms, the M-PBCH subframe carrying a M-PBCH 605 has a periodicity of 10 ms.

In certain embodiments, as shown in FIG. 6B, M-PBCH 605 is mapped across OFDM symbols 0 to 3 in slot #1 of the tenth subframe 640 of each radio subframe, n_{M-PBCH}=9, as shown in FIG. 6B. In a system, such as the LTE system, having a radio frame with a length of 10 ms, the M-PBCH 605 subframe has a periodicity of 10 ms.

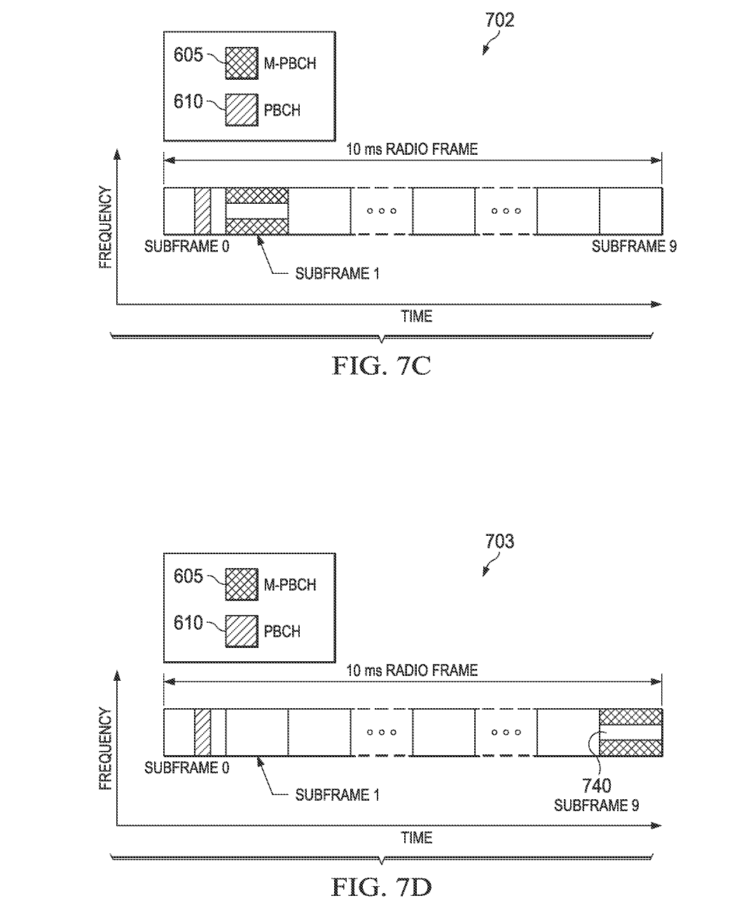

FIGS. 7A through 7D illustrate mapping M-PBCH across a subframe according to embodiments of the present disclosure. The embodiments of the M-PBCH mapping shown in FIGS. 7A through 7D are for illustration only. Other embodiments could be used without departing from the scope of this disclosure.

The M-PBCH 605 is mapped across one or more Physical Resource Blocks (PRBs) out of the center 6 PRBs of the system bandwidth (BW) in a subframe different from the subframe in which the PBCH is transmitted. For example, M-PBCH 605 is transmitted in subframe 1 730 while PBCH is transmitted in subframe 0 720.

In certain embodiments the PRBs in which M-PBCH is mapped are selected to be central, consecutive PRBs out of the center 6 PRBs of the system BW (downlink BW). That is, M-PBCH 605 can occupy N pairs of PRBs out of the center 6 PRBs in a subframe different from the subframe in which the PBCH is transmitted. For example, when the center 6 PRBs are numbered as {0, 1, 2, 3, 4, 5}, PRBs {2, 3} are selected if N=2, and PRBs {2, 3, 4} are selected when N=3. Then, M-PBCH 605 is mapped across the selected N PRBs out of the center 6 PRBs of the system BW in a subframe different from the subframe in which the PBCH is transmitted.

In the example shown in FIG. 7A, the PBCH 610 is sent in the first subframe 720 in the frame. M-PBCH 605 is mapped across one or more central, consecutive PRBs out of the center 6 PRBs of the system BW in the second subframe 730, where n_{M-PBCH}=1, with periodicity of 10 ms. In certain embodiments, as shown in the example of mapping 701 shown in FIG. 7B, M-PBCH 605 is sent in the tenth subframe 740 across one or more, central, consecutive PRBs, where n_{M-PBCH}=9.

In certain embodiments, the PRBs in which M-PBCH 605 is mapped across are selected to be evenly distributed N PRBs out of the center 6 PRBs of the system BW. For example, when N=2, the two edge PRBs {0, 5} out of the center 6 PRBs can be used for M-PBCH mapping. In another example, when N=3, the M-PBCH 605 is sent across PRBs {0, 3, 5} or PRBs {0, 2, 5}. Mapping the M-PBCH 605 to evenly distributed PRBs provides frequency diversity for reliable demodulation of M-PBCH. In the example shown in FIG. 7C, in the M-PDCH mapping 702, the PBCH 610 is sent in the first subframe 720 in the frame and the M-PBCH 605 is mapped across two edge PRBs out of the center 6 PRBs of the system BW in the second subframe 730, where n_{M-PBCH}=1, with periodicity of 10 ms. In the example shown in FIG. 7D, in the M-PDCH mapping 703, the PBCH 610 is sent in the first subframe 720 in the frame and the M-PBCH 605 is mapped across two edge PRBs out of the center 6 PRBs of the system BW in the tenth subframe 740, where n_{M-PBCH}=9, with periodicity of 10 ms.

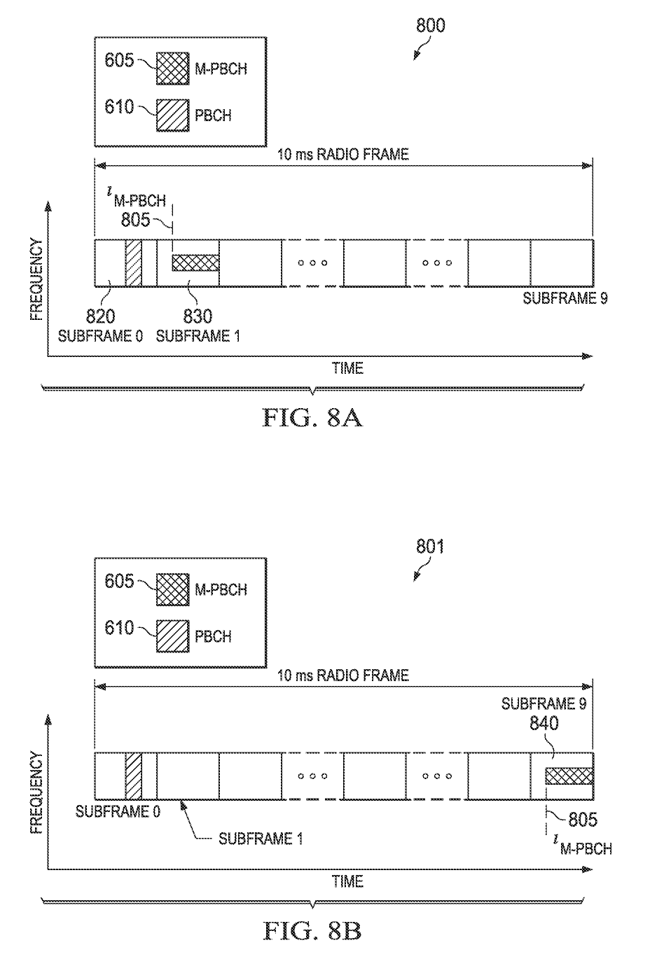

FIGS. 8A through 8D illustrate mapping M-PBCH across a subframe with an offset, i.e., l_{M-PBCH} 800, 801, 802, 803 according to embodiments of the present disclosure. The embodiments of the M-PBCH mapping across a subframe with an offset shown in FIGS. 8A through 8D are for illustration only. Other embodiments could be used without departing from the scope of this disclosure.

In certain embodiments, the M-PBCH 805 is mapped across a subframe from a starting OFDM symbol in the first slot to the last OFDM symbol in the second slot. Considering the multiplexing of M-PBCH and PBCH, the M-PBCH starting position in terms of OFDM symbol number, l_{M-PBCH} is designed and known at the MTC-UE. That is, the starting OFDM symbol, l_{M-PBCH} 805, is configured to avoid collision with any legacy control channel, such as based on the maximum legacy control region. Furthermore, with no CRS support on an extension carrier, no PDCCH region is supported.

As illustrated in FIGS. 8A through 8D, M-PBCH 605 is mapped across one or more Physical Resource Blocks (PRBs) with an offset, l_{M-PBCH} 805 according to the embodiments illustrated in FIGS. 7A through 7D.

In one example, the M-PBCH 605 is mapped across one or more Physical Resource Blocks (PRBs) starting from the fourth OFDM symbol in the subframe if l_{M-PBCH}=3, or the fifth OFDM symbol in the subframe if l_{M-PBCH}=4.

In another example, the starting OFDM symbol, l_{M-PBCH} is selected out of a set of candidate OFDM symbol values, e.g., {3, 4} or {0, 3, 4}. The UE blindly detects the selected starting OFDM symbol from the set of candidate OFDM symbol values.

In still another example, the starting OFDM symbol, l_{M-PBCH} is determined depending on the carrier type. In other words, on a first carrier type, l_{M-PBCH} is the first value. Alternatively, on a second carrier type, l_{M-PBCH} is the second value. In one example, the first carrier type is, i.e., Rel-8 compatible LTE carrier with CRS and legacy control (i.e., PDCCH) region, and the second carrier type is the new carrier type e.g., without CRS and legacy control region. In the example, mapping of the M-PBCH 605 in the first carrier starts from the fourth OFDM symbol, l_{M-PBCH}=3; and mapping of the M-PBCH 605 in the second carrier starts from the first OFDM symbol, l_{M-PBCH}=0. Alternatively, M-PBCH 605 in the first carrier starts from the fifth OFDM symbol, l_{M-PBCH}=4; and M-PBCH 605 in the second carrier starts from the first OFDM symbol l_{M-PBCH}=0. The MTC UE is able to determine the carrier types depending on the PSS/SSS mapping based on an assumption that the PSS/SSS mappings are different in the two different carrier types.

In certain embodiments, for transmission schemes for PBCH 610, a base station transmits M-PBCH 605 using one of a single-layer scheme and a transmit diversity (TxD) scheme. The MTC UE blindly detects the transmission scheme and tries to demodulate and decode M-PBCH under two hypotheses of the single-layer scheme and the Alamouti SFBC or Alamouti STBC. For example, a base station adopts a single-layer scheme on, i.e., AP 7. Alternatively, a base station adopts Alamouti Space-Frequency Block Code (SFBC) or Alamouti Space-Time Block Code (STBC) on, i.e., APs 7 and 8, or APs 7 and 9. In another example, the M-PBCH transmission scheme for MTC UEs is fixed to be either one of the single-layer scheme, and the Alamouti SFBC or Alamouti STBC.

When a TxD scheme is used for M-PBCH transmission, the MTC UE assumes that each AP's DMRS are for the same channel across all the M-PBCH PRBs.

In embodiments where the single-layer scheme is used for transmitting M-PBCH via i.e., AP 7, the following options are considered for an MTC UE's assumption on the inter-PRB channels. In one option, the same precoder is applied to all the M-PBCH PRBs and the MTC UE detects the transmission based on the assumption that the same precoder was used. This option is useful for improving the MTC UEs' channel estimation performance.

In another option, different precoders are applied to different M-PBCH PRBs and the UE can detect the transmission based on the assumption that different precoders were used in different M-PBCH PRBs. For example, a base station can choose precoders such that each PRB experiences different effective channels, just as in the precoder cycling case in Rel-8 LTE open loop MIMO defined as a diversity scheme, which would eventually help M-PBCH detection performance.

In another option, PBRs carrying M-PBCH 605 are bundled into the smaller sets of PRBs consisting of 2 or 3 PRBs. The same precoder is applied to PRBs forming within each set, and different precoders are applied to different sets of PRBs. In one example of 2 PRB bundling, center 6 PRBs are bundled to form 3 sets of, i.e., (0, 1), (2, 3) and (4, 5). In the example, PRBs 0 and 1 are applied with the first type of precoder, PRBs 2 and 3 are applied with the second type of precoder, and PRBs 4 and 5 are applied with the third type of precoder.

In certain embodiments, the base station applies the DMRS scrambling sequence for the MTC UE. For calculating DMRS scrambling sequences, the center 6 PRBs can have new index numbers.

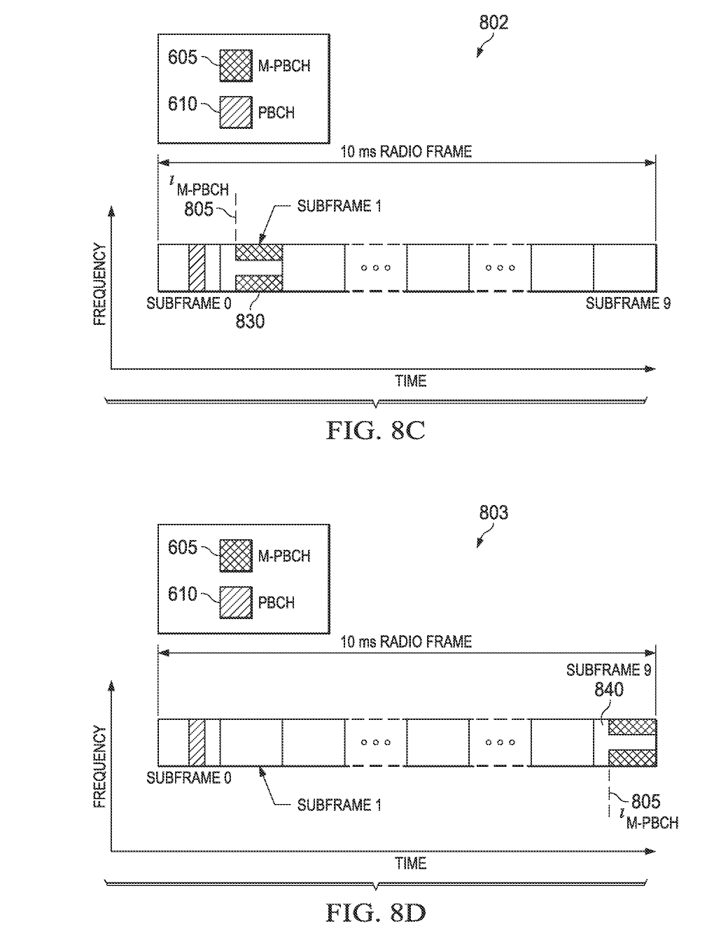

FIG. 9 illustrates an independent PRB indexing for the center 6 PRBs of the system BW according to embodiments of the present disclosure. The embodiment of the PRB indexing 900 shown in FIG. 9 is for illustration only. Other embodiments could be used without departing from the scope of this disclosure.

In the example shown in FIG. 9, the PRB index 905 for center 6 PRB 910 is denoted as n_{PRB,MTC} and is independently numbered as {0, 1, 2, 3, 4, 5} regardless of the actual BW. The scrambling sequence for DMRS APs 7-14 are generated using n_{PRB,MTC}, instead of n_{PRB}. As specified in 6.10.3.2 “Mapping to resource elements” of REF1, for antenna ports p=7, p=8 or p=7, 8, . . . , ν+6, in a physical resource block with frequency-domain index n_{PBR,MTC} assigned for the corresponding PDSCH transmission, a part of the reference signal sequence r(m) is mapped to complex-valued modulation symbols a_{kJ}^{(p)} in a subframe according to, for Normal cyclic prefix:

$$\begin{matrix}{a}_{k , l}^{( p )} = {w}_{p} ( {l}^{′} ) \cdot r ( 3 \cdot {l}^{′} \cdot {N}_{RB}^{max , DL} + 3 \cdot {n}_{PRB , MTC} + {m}^{′} ) \\ where \\ {w}_{p} ( i ) = \{ \begin{matrix}{\overline{w}}_{p} ( i ) & ( {m}^{′} + {n}_{PRB} ) mod 2 = 0 \\ {\overline{w}}_{p} ( 3 - i ) & ( {m}^{′} + {n}_{PRB} ) mod 2 = 1\end{matrix} \\ k = 5 {m}^{′} + {N}_{sc}^{RB} {n}_{PRB} + {k}^{′} \\ {k}^{′} = \{ \begin{matrix}1 & p ∈ \{ 7 , 8 , 11 , 13 \} \\ 0 & p ∈ \{ 9 , 10 , 12 , 14 \}\end{matrix} \\ 1 = \{ \begin{matrix}{1}^{′} mod 2 + 2 & \begin{matrix}if in a special subframe with configuration \\ 3 , 4 , or 8 ( see Table 1 )\end{matrix} \\ {1}^{′} mod 2 + 2 + 3 ⌊ \frac{{1}^{′}}{2} ⌋ & \begin{matrix}if in a special subframe with configuration \\ 1 , 2 , 6 , or 7 ( see Table 1 )\end{matrix} \\ {1}^{′} mod 2 + 5 & if not in a special subframe\end{matrix} \\ {1}^{′} = \{ \begin{matrix}0 , 1 , 2 , 3 & \begin{matrix}if {n}_{s} mod 2 = 0 and in a special subframe \\ with configuration 1 , 2 , 6 , or 7 ( see Table 1 )\end{matrix} \\ 0 , 1 & \begin{matrix}if {n}_{s} mod 2 = 0 and not in special subframe \\ with configuration 1 , 2 , 6 , or 7 ( see Table 1 )\end{matrix} \\ 2 , 3 & \begin{matrix}if {n}_{s} mod 2 = 1 and not in special subframe \\ with configuration 1 , 2 , 6 , or 7 ( see Table 1 )\end{matrix}\end{matrix} \\ {m}^{′} = 0 , 1 , 2 \\ and for Extended cyclic prefix \text{:} & ( 1 ) \\ {a}_{k , l}^{( p )} = {w}_{p} ( {l}^{′} ) \cdot r ( 4 \cdot {l}^{′} \cdot {N}_{RB}^{max , DL} + 4 \cdot {n}_{PRB , MTC} + {m}^{′} ) \\ where \\ {w}_{p} ( i ) = \{ \begin{matrix}{\overline{w}}_{p} ( i ) & {m}^{′} mod 2 = 0 \\ {\overline{w}}_{p} ( 1 - i ) & {m}^{′} mod 2 = 1\end{matrix} \\ k = 3 {m}^{′} + {N}_{sc}^{RB} {n}_{PRB} + {k}^{′} \\ {k}^{′} = \{ \begin{matrix}1 & if {n}_{s} mod 2 = 0 and p ∈ \{ 7 , 8 \} \\ 2 & if {n}_{s} mod 2 = 1 and p ∈ \{ 7 , 8 \}\end{matrix} \\ 1 = {1}^{′} mod 2 + 4 \\ {1}^{′} = \{ \begin{matrix}0 , 1 & \begin{matrix}if {n}_{s} mod 2 = 0 and in a special subframe \\ with configuration 1 , 2 , 3 , 5 , or 6 ( see Table 1 )\end{matrix} \\ 0 , 1 & if {n}_{s} mod 2 = 0 and not in a special subframe \\ 2 , 3 & if {n}_{s} mod 2 = 1 and not in a special subframe\end{matrix} \\ {m}^{′} = 0 , 1 , 2 , 3 & ( 2 )\end{matrix}$$

UL-DL subframe configurations for TDD are shown as in Table

TABLE 1

| | Downlink- | | | | | | | | | | |
|---|---|---|---|---|---|---|---|---|---|---|---|
| Uplink- | to-Uplink | | | | | | | | | | |
| downlink | Switch-point | Subframe number | | | | | | | | | |
| configuration | periodicity | 0 | 1 | 2 | 3 | 4 | 5 | 6 | 7 | 8 | 9 |
| 0 | 5 ms | D | S | U | U | U | D | S | U | U | U |
| 1 | 5 ms | D | S | U | U | D | D | S | U | U | D |
| 2 | 5 ms | D | S | U | D | D | D | S | U | D | D |
| 3 | 10 ms | D | S | U | U | U | D | D | D | D | D |
| 4 | 10 ms | D | S | U | U | D | D | D | D | D | D |
| 5 | 10 ms | D | S | U | D | D | D | D | D | D | D |
| 6 | 5 ms | D | S | U | U | U | D | S | U | U | D |

In certain embodiments, the base station generates the scrambling sequence for MTC-UEs with the new PRB indexing, n_{PRB,MTC} within the center 6 PRBs, which can be different from the scrambling sequence used for non-MTC UEs if they were assigned these same PRBs. In some embodiments, a fixed SCID=0 can be used for MTC UEs.

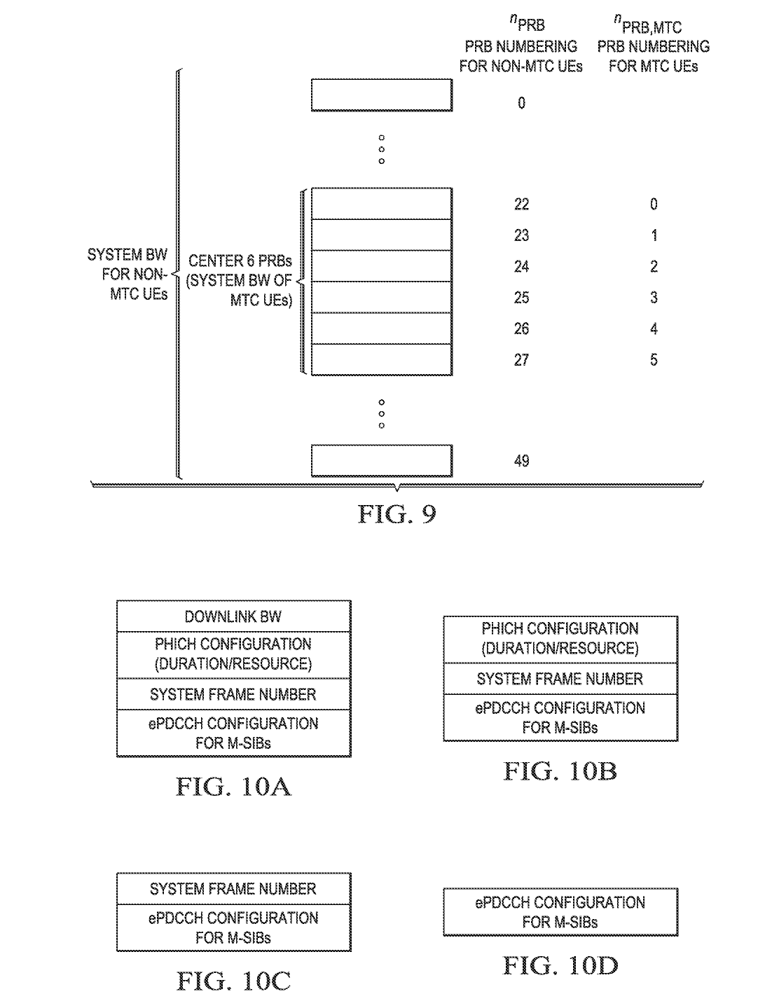

FIGS. 10A through 10F illustrate M-MIB structures according to embodiments of the present disclosure. The embodiments of the M-MIB structures shown in FIGS. 10A through 10Ff) are for illustration only. Other embodiments could be used without departing from the scope of this disclosure.

In certain embodiments, M-MIB contains either information to access M-SIB carrying information specific to a MTC UE, or one or more M-SIBs.

As shown in FIG. 10A, an M-MIB 1000 includes information to access M-SIB (s) carrying information specific to an MTC UE, denoted as M-SIB(s), such as configuration information of ePDCCH 1005 (time-frequency location/search space, DMRS port mapping, and the like) that points to the M-SIB(s), in addition to downlink BW 1010, PHICH configuration (duration/resource) 1015, and a System Frame Number (SFN) 1020.

If MTC bandwidth is fixed to, i.e., 1.4 MHz, information on Downlink BW 1010 can be removed, as shown in FIG. 10B.

In another embodiment, M-MIB 1000 includes a System Frame Number 1020 and ePDCCH configuration 1005 for M-SIB(s), and the downlink BW 1010 and the PHICH configuration 1015 are not transmitted in M-MIB, as illustrated in FIG. 10C.

In still another embodiment, M-MIB 1000 includes information of the ePDCCH configuration 1005 for M-SIB(s), as illustrated in FIG. 10D.

In still another embodiment, as illustrated in FIG. 10E, M-MIB 1000 includes a plurality of M-SIBS 1025, i.e., M-SIB 1, M-SIB 2, and the like. M-MIB 1000 can be increased in size by containing M-SIBs, if necessary. In certain embodiment, M-SIB(s) can contain ePDCCH configuration for MTC-UEs.

In still another embodiment, as illustrated in FIG. 10F, M-MIB 1000 also is used to indicate certain configuration information of subframes, RBs, and the like, where a UE expects to receive paging/data transmissions on the downlink. The UE only wakes-up and looks for control information/ePDCCH only in these resources. For this purpose, M-PCFICH 1030 can be designed, which can indicate time-frequency location of the ePDCCH search space for the MTC UEs.

Here, the M-PCFICH 1030 and ePDCCH configuration could be regarding the common search space for all the MTC UEs camped on the carrier. In addition, in some of the methods described above, the information on the M-PCFICH 1030 and ePDCCH configuration can be appended to the MIB replacing the reserved bits. The proposed M-MIB designs may be mapped to the solutions based on reusing the existing PBCH channel or the modified PBCH channel described earlier.

In general, for better support in future releases for MTC UEs, it is preferable that MTC UEs operate in a bandwidth agnostic manner. Note that with the designs proposed herein, an MTC UE operates in center 6 PRBs of a system BW without knowledge of the bandwidth configuration for non-MTC UEs and autonomously in new carrier types (without an anchor carrier).

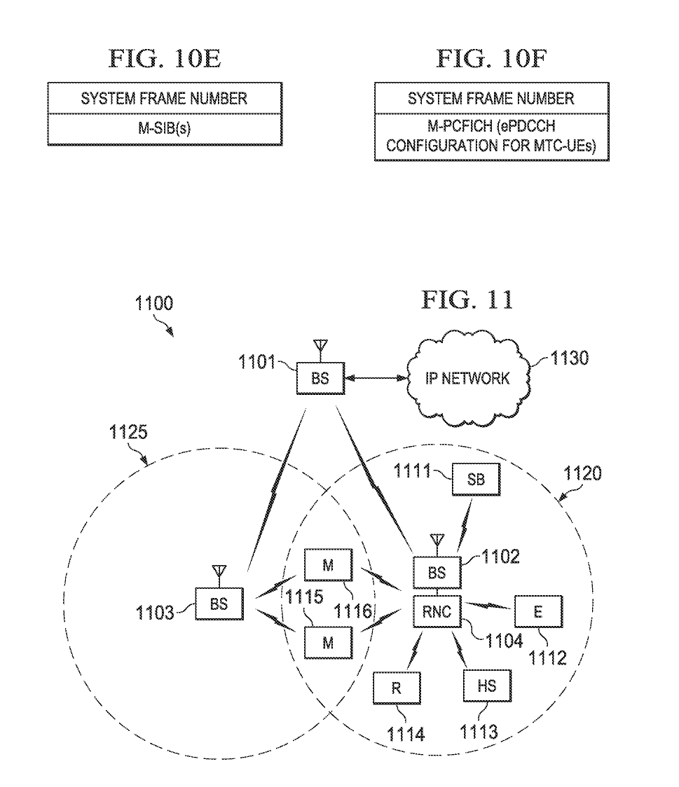

FIG. 11 illustrates an exemplary wireless network 1100 according to one embodiment of the present disclosure. In the illustrated embodiment, the wireless network 1100 includes base station (BS) 1101, base station 1102, and base station 1103. Base station 1101 communicates with base station 1102 and base station 1103. Base station 1101 also communicates with Internet protocol (IP) network 1130, such as the Internet, a proprietary IP network, or other data network. Base station 1102 communicates with a Radio Network Controller (RNC) 1104. In certain embodiments, the RNC 1104 may be a part of base station 1102. In certain embodiments, base station 1101 and base station 1103 may also communicate with the RNC 1104. In other embodiments, base station 1101 and base station 1103 may include or be in communication with another radio network controller similar to the RNC 1104. Base station 1102 or base station 1103 may communicate with IP network 1130 using wireline, instead of communicating with base station 1101 wirelessly.

Base station 1102, either in cooperation with the RNC 1104 or through the RNC 1104, provides wireless broadband access to the network 1130 to a first plurality of subscriber stations within a coverage area 1120 of base station 1102. The first plurality of subscriber stations includes subscriber station (SS) 1111, subscriber station 1112, subscriber station 1113, subscriber station 1114, subscriber station 1115, and subscriber station 1116. Subscriber stations 1111-1116 may be any wireless communication device, such as, but not limited to, a mobile phone, mobile PDA, and any mobile station (MS). In an exemplary embodiment, SS 1111 may be located in a small business (SB), SS 1112 may be located in an enterprise (E), SS 1113 may be located in a WiFi hotspot (HS), SS 1114 may be located in a residence (R), and SS 1115 and SS 1116 may be mobile devices (M).

Base station 1103 provides wireless broadband access to the network 1130 via base station 1101 to a second plurality of subscriber stations within a coverage area 1125 of base station 1103. The second plurality of subscriber stations includes subscriber station 1115 and subscriber station 1116. In alternate embodiments, base stations 1102 and 1103 may be connected directly to the Internet by means of a wired broadband connection, such as an optical fiber, DSL, cable, or T1/E1 line, rather than indirectly through base station 1101.

In other embodiments, base station 1101 may be in communication with either fewer or more base stations. Furthermore, while only six subscriber stations are shown in FIG. 11, it is understood that the wireless network 1100 may provide wireless broadband access to more than six subscriber stations. It is noted that subscriber station 1115 and subscriber station 1116 are on the edge of both coverage area 1120 and coverage area 1125. Subscriber station 1115 and subscriber station 1116 each communicate with both base station 1102 and base station 1103 and may be said to be cell-edge devices interfering with each other. For example, the communications between BS 1102 and SS 1116 may be interfering with the communications between BS 1103 and SS 1115. Additionally, the communications between BS 1103 and SS 1115 may be interfering with the communications between BS 1102 and SS 1116.

Subscriber stations 1111-1116 may use the broadband access to network 1130 to access voice, data, video, video teleconferencing, and/or other broadband services. In an exemplary embodiment, one or more of subscriber stations 1111-1116 may be associated with an access point (AP) of a WiFi WLAN. Subscriber station 1116 may be any of a number of mobile devices, including a wireless-enabled laptop computer, personal data assistant, notebook, handheld device, or other wireless-enabled device. Subscriber station 1114 may be, for example, a wireless-enabled personal computer, a laptop computer, a gateway, or another device.

Dotted lines show the approximate extents of coverage areas 1120 and 1125, which are shown as approximately circular for the purposes of illustration and explanation only. It should be clearly understood that the coverage areas associated with base stations, for example, coverage areas 1120 and 1125, may have other shapes, including irregular shapes, depending upon the configuration of the base stations and variations in the radio environment associated with natural and man-made obstructions.

Also, the coverage areas associated with base stations are not constant overtime and may be dynamic (expanding, contracting, or changing shape) based on changing transmission power levels of the base station and/or the subscriber stations, weather conditions, and other factors. In one example, the radius of the coverage areas 1120 and 1125 of base stations 1102 and 1103 may extend in the range from less than 2 kilometers to about 50 kilometers from the base stations.

As is well known in the art, a base station, such as base station 1101, 1102, or 1103, may employ directional antennas to support a plurality of sectors within the coverage area. In FIG. 11, base stations 1102 and 1103 are depicted approximately in the center of coverage areas 1120 and 1125, respectively. In other embodiments, the use of directional antennas may locate the base station near the edge of the coverage area, for example, at the point of a cone-shaped or pear-shaped coverage area.

Although FIG. 11 depicts one example of a wireless network 1100, various changes may be made to FIG. 11. For example, another type of data network, such as a wired network, may be substituted for the wireless network 1100. In a wired network, network terminals may replace BS's 1101-1103 and MTC UE's 1111-1116. Wired connections may replace the wireless connections depicted in FIG. 11.

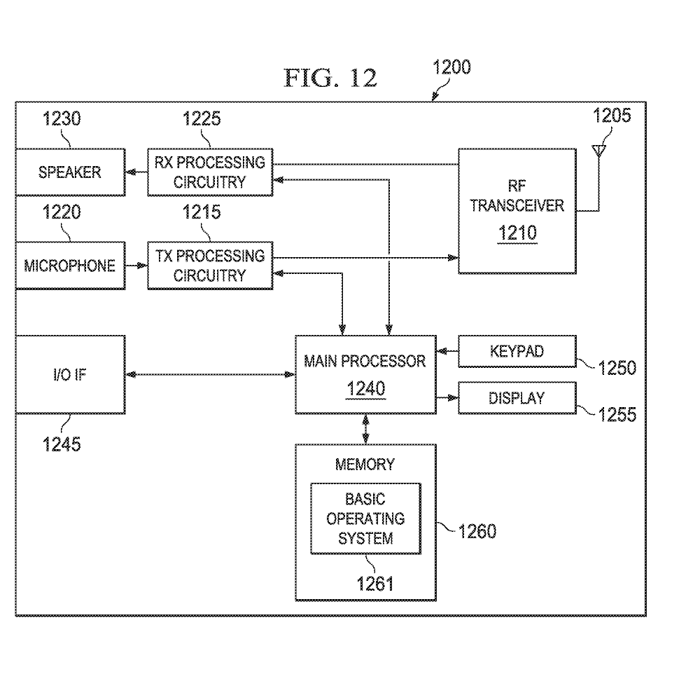

FIG. 12 illustrates a wireless mobile station according to embodiments of the present disclosure. In certain embodiments, the wireless mobile station 1200 may represent any of the MTC UEs 1111-1116 shown in FIG. 11. The embodiment of the wireless mobile station 1200 illustrated in FIG. 12 is for illustration only. Other embodiments of the wireless mobile station 1200 could be used without departing from the scope of this disclosure.

The wireless mobile station 1200 comprises an antenna 1205, a radio frequency (RF) transceiver 1210, transmit (TX) processing circuitry 1215, a microphone 1220, receive (RX) processing circuitry 1225, and a speaker 1230. The mobile station 1200 also comprises a main processor 1240, an input/output (I/O) interface (IF) 1245, a keypad 1250, a display 1255, and a memory 1260.

The RF transceiver 1210 receives from the antenna 1205 an incoming RF signal transmitted by a base station of the wireless network. The RF transceiver 1210 down-converts the incoming RF signal to produce an intermediate frequency (IF) or a baseband signal. The IF or baseband signal is sent to the RX processing circuitry 1225 that produces a processed baseband signal by filtering, decoding, and/or digitizing the baseband or IF signal. The RX processing circuitry 1225 transmits the processed baseband signal to the speaker 1230 (i.e., voice data) or to the main processor 1240 for further processing (e.g., web browsing).

The TX processing circuitry 1215 receives analog or digital voice data from the microphone 1220 or other outgoing baseband data (e.g., web data, e-mail, interactive video game data) from the main processor 1240. The TX processing circuitry 1215 encodes, multiplexes, and/or digitizes the outgoing baseband data to produce a processed baseband or IF signal. The RF transceiver 1210 receives the outgoing processed baseband or IF signal from the TX processing circuitry 1215. The RF transceiver 1210 up-converts the baseband or IF signal to an RF signal that is transmitted via the antenna 1205.

In some embodiments of the present disclosure, the main processor 1240 is processing circuitry, such as a microprocessor or microcontroller. The memory 1260 is coupled to the main processor 1240. The memory 1260 can be any computer-readable medium. For example, the memory 1260 can be any electronic, magnetic, electromagnetic, optical, electro-optical, electro-mechanical, and/or other physical device that can contain, store, communicate, propagate, or transmit a computer program, software, firmware, or data for use by the microprocessor or other computer-related system or method. According to such embodiments, part of the memory 1260 comprises a random access memory (RAM) and another part of the memory 1260 comprises a Flash memory, which acts as a read-only memory (ROM).

The main processor 1240 executes a basic operating system 1261 stored in the memory 1260 in order to control the overall operation of the mobile station 1200. In one such operation, the main processor 1240 controls the reception of forward channel signals and the transmission of reverse channel signals by the RF transceiver 1210, the RX processing circuitry 1225, and the TX processing circuitry 1215, in accordance with well-known principles.

The main processor 1240 is capable of executing other processes and programs resident in the memory 1260. The main processor 1240 can move data into or out of the memory 1260, as required by an executing process. The main processor 1240 can move data into or out of the memory 1260, as required by an executing process. The main processor 1240 is also coupled to the I/O interface 1245. The I/O interface 1245 provides the mobile station 1200 with the ability to connect to other devices, such as laptop computers and handheld computers. The I/O interface 1245 is the communication path between these accessories and the main processor 1240.

The main processor 1240 is also coupled to the keypad 1250 and the display 1255. The operator of the mobile station 1200 uses the keypad 1250 to enter data into the mobile station 1200. The display 1255 may be a liquid crystal or light emitting diode (LED) display capable of rendering text and/or graphics from web sites. Alternate embodiments may use other types of displays. For example, for an embodiment in which the display 1255 is a touch-screen display, the keypad 1250 may be provided via the display 1255.

For some embodiments, the mobile station 1200 is configured to receive SIBS as described herein above. The main processor 1240 executes function to process the PBCH, SIBS, and M-PDCCH.

Although FIG. 12 depicts one example of a mobile station 1200, various changes may be made to FIG. 12. For example, a wired or wireless network terminal may be substituted for the mobile station 1200. A wired network terminal may or may not include components for wireless communication, such as an antenna.

Although various features have been shown in the figures and described above, various changes may be made to the figures. For example, the size, shape, arrangement, and layout of components shown in FIGS. 1-12 are for illustration only. Each component could have any suitable size, shape, and dimensions, and multiple components could have any suitable arrangement and layout. Also, various components in FIGS. 1-12 could be combined, further subdivided, or omitted and additional components could be added according to particular needs. Further, each component in a device or system could be implemented using any suitable structure(s) for performing the described function(s). In addition, although illustrated as individual embodiments, various embodiments can be combined with other embodiments in whole or in part without departing from the scope of the present disclosure.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. For use in a wireless network, a method for supporting a Machine-Type Communication (MTC) User Equipment (UE), the method comprising:
transmitting an MTC-specific Master Information Block (M-MIB) carrying information specific to a User Equipment (UE), via a MTC Physical Broadcast Channel (M-PBCH) to the MTC UE,
wherein the M-PBCH is transmitted in a M-PBCH subframe being different from a Physical Broadcast Channel (PBCH) subframe in which a PBCH is transmitted.

2. The method of claim 1, wherein the PBCH subframe is a first subframe of a frame according to 3rd Generation Partnership Project (3GPP) standards.

3. The method of claim 2, wherein the M-PBCH subframe is either a second subframe or a tenth subframe in a frame.

4. The method of claim 1, wherein the M-PBCH is located to within OFDM symbols 0-3 in a second slot of the M-PBCH subframe.

5. The method of claim 1, wherein the M-PBCH is mapped across one or more Physical Resource Blocks (PRBs) from a starting OFDM symbol toward an end of the M-PBCH subframe in each row of subcarriers.

6. The method of claim 5, wherein the starting OFDM symbol is one of a third OFDM symbol, a fourth OFDM symbol, and a selected one out of a set of candidate OFDM symbol values.

7. The method of claim 1, wherein the M-PBCH occupies either central, consecutive Physical Resource Blocks (PRBs), or evenly distributed, central PRBs of a downlink bandwidth.

8. The method of claim 1, wherein the M-PBCH is precoded by either a single-layer scheme or a Transmit Diversity (TxD) scheme.

9. The method of claim 1, wherein the M-PBCH includes DeModulation Reference Signal (DMRS) for the MTC-UE, the DMRS being generated using independent index of central PRBs of a downlink bandwidth.

10. The method of claim 1, wherein the M-MIB contains either information to access a MTC System Information Block (M-SIB) carrying information specific to the MTC UE, or at least one M-SIB.

11. A base station configured to communicate with at least one user equipment (UE) for machine type communication (MTC), the base station comprising:
a transmitter configured to transmit an MTC-specific Master Information Block (M-MIB) carrying information specific to User Equipment (UE), via a MTC Physical Broadcast Channel (M-PBCH) to MTC UE,
wherein the M-PBCH is transmitted in a M-PBCH subframe being different from a Physical Broadcast Channel (PBCH) subframe in which a PBCH is transmitted.

12. The base station of claim 11, wherein the M-PBCH subframe is either a second subframe or a tenth subframe in a frame.

13. The base station of claim 11, wherein the M-PBCH is located to within OFDM symbols 0 to 3 in a second slot of the M-PBCH subframe.

14. The base station of claim 11, wherein the M-PBCH is mapped across one or more Physical Resource Blocks (PRBs) from a starting OFDM symbol toward an end of a second slot of the M-PBCH subframe in each row of subcarriers.

15. The base station of claim 14, wherein the starting OFDM symbol is one of a third OFDM symbol, a fourth OFDM symbol, and a selected one out of a set of candidate OFDM symbol values.

16. The base station of claim 11, wherein the M-PBCH occupies either central, consecutive Physical Resource Blocks (PRBs), or evenly distributed, central PRBs of a downlink bandwidth.

17. The base station of claim 11, wherein the M-PBCH is precorded by either a single-layer scheme or a Transmit Diversity (TxD) scheme.

18. The base station of claim 11, wherein the M-PBCH includes DeModulation Reference Signal (DMRS) for the MTC-UE, the DMRS being generated using independent index of center PRBs of a downlink bandwidth.

19. The base station of claim 1, wherein the M-MIB contains either information to access M-SIB carrying information specific to a MTC UE, or at least one M-SIB.

20. A machine type communication (MTC) User Equipment (UE) configured to communicate with at least one base station, the MTC UE comprising:
a receiver configured to receive an MTC-specific Master Information Block (M-MIB) carrying information specific to User Equipment (UE), via a MTC Physical Broadcast Channel (M-PBCH) to MTC UE,
wherein the M-PBCH is received in a M-PBCH subframe being different from a Physical Broadcast Channel (PBCH) subframe in which a PBCH is received.
